(19) United States
(12) Patent Application Publication
(10) Pub. No.: US 2011/0079677 A1
(43) Pub. Date: Apr. 7, 2011

(54) Ornithopter

(76) Inventor: Nathan J. Chronister, Rochester, NY (US)

(21) Appl. No.: 12/924,592

(22) Filed: Sep. 30, 2010

Related U.S. Application Data
(60) Provisional application No. 61/278,126, filed on Oct. 5, 2009.

(51) Int. Cl. B64C 33/00

(52) U.S. Cl. 244/11

(57) ABSTRACT

The claimed invention is an ornithopter with three improvements over previous designs. First, it has a more efficient wing. Instead of using a heavy bracing rod to regulate the flexibility of the wing, it uses a lightweight cable tension system. Second, it has a steering mechanism that separates the servos from the tail itself, reducing the likelihood of damage in the event of a crash. Third, the ornithopter has a modular design, which allows more control over the external appearance of the model. Various bodies can be used with the same drive mechanism, and it permits the individual hobbyist or the kit manufacturer to produce additional body designs without having to take on the complex task of designing a new flapping mechanism.

### CROSS-REFERENCE TO RELATED APPLICATIONS

This application claims the benefit of Provisional Patent Application Ser. No. 61/278,126, filed Oct. 5, 2009 by the present inventor.

### STATEMENT REGARDING FEDERALLY SPONSORED RESEARCH OR DEVELOPMENT

This invention was not produced under federally sponsored research or development.

### REFERENCE TO SEQUENCE LISTING, A TABLE, OR A COMPUTER PROGRAM LISTING COMPACT DISC APPENDIX

No compact disc is being submitted.

### BACKGROUND OF THE INVENTION

Ornithopters, or flapping-wing aircraft, are becoming popular among radio-control hobby enthusiasts. Their appeal lies in the fact that they fly like a bird. Many hobbyists regard this as an exciting form of recreation. Some of the barriers to further development include poor efficiency, difficulty of customizing the models or developing new designs, and poor resemblance to real birds. Additionally, typical ornithopter steering mechanisms are fragile compared with airplane steering mechanisms.

U.S. Pat. No. 6,550,716, assigned to Neuros Co., Ltd., describes a typical radio controlled ornithopter. Three aspects of the ornithopter design are of particular interest here: 1) the wing structure, 2) the steering mechanism, and 3) the appearance and construction of the body or fuselage.

1) Wing Structure. The wing structure of U.S. Pat. No. 6,550,716 assigned to Neuros Co., Ltd., consists of a fabric sail with battens. The wing must be able to change shape aeroelastically, taking on a cambered shape as it passes through the air, but it must not be overly flexible. Therefore, the wing is braced by a semi-flexible rod, introduced in U.S. Pat. No. 2,859,553 (P. H. Spencer). The stiffness or diameter of this bracing rod must be correctly chosen in order to achieve the correct degree of flexibility. The bracing rod is heavy, and it interferes with the profile of the wing, causing air resistance.

2) Steering Mechanism. U.S. Pat. No. 6,550,716 (Neuros Co., Ltd.) includes a steering mechanism that is typical of radio-controlled ornithopters. U.S. Patent Application #2002/0173217 by Andrew Sean Kinkade describes a similar system. The aircraft has a tail controlled by two hobby servos. One servo moves the tail up and down. The other servo moves the tail left and right, for steering. Maneuverability of the aircraft is similar to that of an airplane with rudder and elevator controls. However, the tail has to be mounted directly onto the servo output arm, causing the servo to break easily.

3) Appearance of the Fuselage. Most radio-controlled ornithopters have used a body frame that has been milled from a flat sheet of composite material, such as fiberglass. This technique simplifies the construction, but it results in a thin, flat, body, which does not resemble the three-dimensional body of a real bird. Moreover, all of the radio system components are mounted externally on the flat plate fuselage. A realistic appearance would require a three-dimensional, hollow body, with components mounted inside. Although the ornithopter of U.S. Pat. No. 6,550,716 (Neuros Co., Ltd.) provides a flexible plastic covering over the flat plate fuselage, this must conform to the shape of the underlying frame, and there is little opportunity for hobbyists to customize the appearance.

### BRIEF SUMMARY OF THE INVENTION

The claimed invention is an ornithopter that has an improved, more efficient wing, a steering mechanism that reduces the likelihood of damage to the servos, and a modular design allowing more control over the external appearance of the model. The modular design permits the individual hobbyist to customize the model, and it also creates the opportunity for hobby kit manufacturers to produce additional body designs without having to take on the complex task of designing a new flapping mechanism.

### BRIEF DESCRIPTION OF THE SEVERAL VIEWS OF THE DRAWING

FIG. 1. Overview of preferred embodiment.

FIG. 2. Wing design using cable system.

FIG. 3. Steering mechanism.

FIG. 4. System for attaching body to drive mechanism.

### DETAILED DESCRIPTION OF THE INVENTION

In the preferred embodiment, the present invention consists of an ornithopter, having: 1) a modular design, 2) cable-tensioned wings, 3) and a steering mechanism that reduces the likelihood of damage to the servos by separating them from the tail. These three features may be used in their six other combinations as well, such as an ornithopter that lacks the modular design, but has the cable-tensioned wings and improved steering mechanism. Another alternative embodiment is a free-flight (not radio-controlled) ornithopter, which uses the cable tension system but has no steering mechanism. Certainly as well, the modular design could be used in the absence of the other two improvements. Indeed, the modular approach favors experimentation with various other steering mechanisms, since it becomes possible to try new ones without having to build a whole new ornithopter.

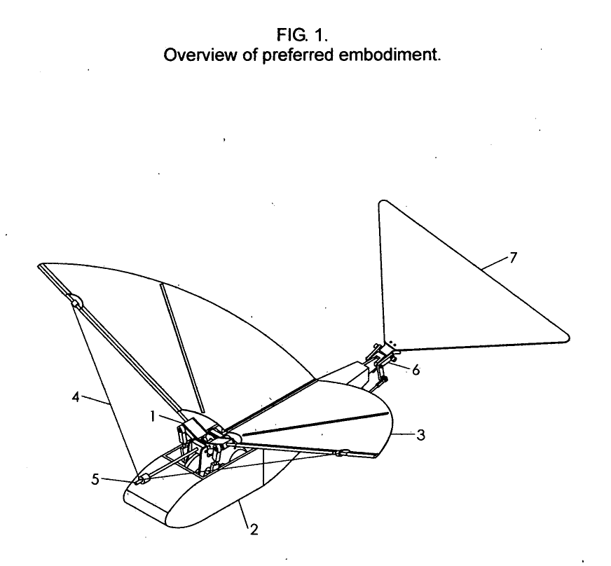

FIG. 1 shows an overview of the preferred embodiment, combining all three design features. The ornithopter consists of a modular drive unit (1), which can be mounted onto one or more interchangeable bodies (2). The modular drive unit typically includes a motor, gear reduction, and cranks for driving the wings. Its design and construction are within the prior art. The drive unit includes two or more wings (3), which are drawn forward by the wing-tensioning cable (4), attached to forward projection (5). The interchangeable bodies may include a steering mechanism (6) that moves the tail (7) in such a way that the tail can move up and down, and rotate about its longitudinal axis.

Typical ornithopter wings consist of a thin membrane on a frame of some strong, lightweight material. The leading edge of the wing surface is attached to a strong spar, which drives the flapping of the wings. Often, a bracing rod, arranged diagonally across the wing, prevents the wing from being too flexible in torsion. The diagonal brace increases the torsional stiffness of the wing by limiting the bending of the leading edge wing spar and by directly supporting the wing surface. However, the diagonal brace creates a ridge across the wing surface, which interferes with the ideal, cambered cross section of the wing, and increases air resistance.

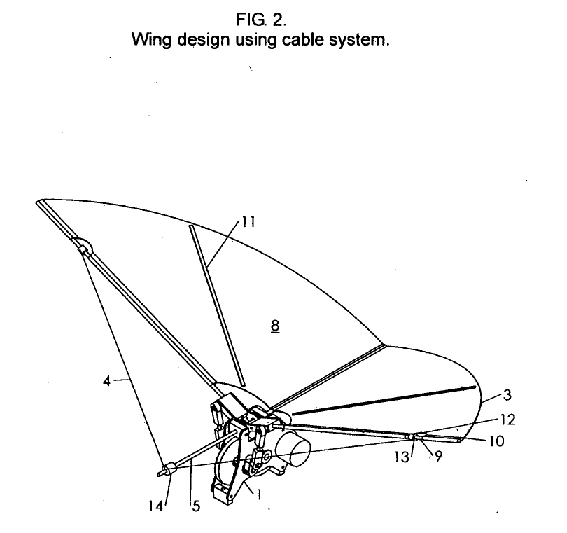

FIG. 2 shows the improved wing structure. The bracing rod has been eliminated. The wing consists of a thin membrane (8), typically made of fabric or a plastic film, sometimes paper. The membrane is attached at its leading edge to a strong spar (9), often by providing a hem (10) at the leading edge, which slips onto the spar, or by simply gluing the membrane onto the spar. The wing spar is typically made of carbon fiber rod or another strong material. The wing membrane may be reinforced by battens (11), which permit the membrane to extend farther outward. The wing tensioning cable (4) is attached to the wing spar. A cut-out opening (12) may be provided for this purpose. For example, it may be tied with a square knot, and prevented from sliding along the spar by gluing it in place on the spar, or by a tight-fitting piece of tubing (13), or any of the manners used in the construction of kites. The cable can be made of any strong cord. Kevlar is preferred, because it does not stretch excessively under load. Tension is provided by attaching the wing tensioning cable to a forward projection (5) of the drive unit (1). In the preferred embodiment, the forward projection has a moveable collar (14) for securing the cable in any desired position, which allows easy adjustment of the amount of tension. Other devices could be used for adjusting the tension, such as a row of hooks attached to the body or to the drive unit.

In the prior art, the tail is typically mounted directly onto one of the servos, and that servo provides for the rotation of the tail about its longitudinal axis. The other servo tilts the rotation servo up and down, the tail along with it. In the event of a crash, the rotation servo can break easily, because the shock load on the tail is transferred directly to this one servo. In the present, improved mechanism, the shock load on the tail is shared by both servos, and conveyed through a linkage, allowing some of the energy to be absorbed before reaching the servo. This reduces the risk of damage to the servos. Since the servos are not subjected to as much stress, lighter servos can be used, which benefits flight performance. Also, the use of more durable and more expensive metal-gear servos might be avoided, and that would lower the cost.

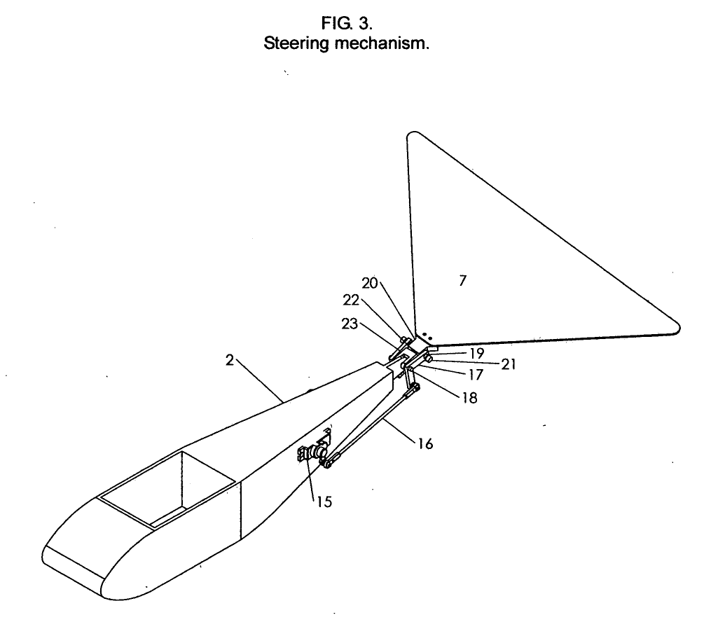

FIG. 3 shows the improved steering mechanism. In this mechanism, the servos (15) are mounted in the body (2), using any of the methods previously used in the construction of model aircraft. Pushrods (16) transfer the servo action to a pair of bellcranks (17). The bellcrank is a hinged lever with approximately a right angle bend at the fulcrum (18). The two bellcranks can pivot independently from each other, each one according to the action of its respective servo. The servo exerts a fore-and-aft motion on its corresponding bellcrank. The output of the bellcrank is a roughly up-and-down motion.

The output of each bellcrank contains a ball and socket joint (19). A ball with a hole through it and typically made of steel or other hard material is free to rotate within a spherical cavity of the bellcrank arm. The ball is fastened to the tail base piece (20) by a machine screw or other fastener (21), allowing the ball to slide along the shaft of the fastener. Alternatively, the ball may be fixed, taking advantage of the flexibility of the parts to provide the required range of motion, or the ball could be eliminated, in favor of a simpler coupling (e.g., screw fitting loosely in hole). The latter will increase play.

The tail base piece has a hole through its longitudinal axis and pivots about the rod (22), which is secured to the body by a fork (23). The fork allows the rod to swing up and down. The fork arrangement could be replaced by some other method of hinging the rod onto the body. When both bellcrank outputs are raised, together, the fork and the tail base piece swing upward. When both bellcrank outputs are lowered, together, the fork and the tail base piece swing down. This provides an up-and-down motion of the tail (7). Moving the bellcranks in opposite directions causes the tail base piece to rotate about the rod. This provides the steering motion of the tail.

Additional variations are possible, such as using ball-link connecting rods to link the servo to the bellcrank, or using ball bearings in the mechanism to reduce friction. In the preferred embodiment, these variations are not depicted, because they would add additional complexity, weight, and cost.

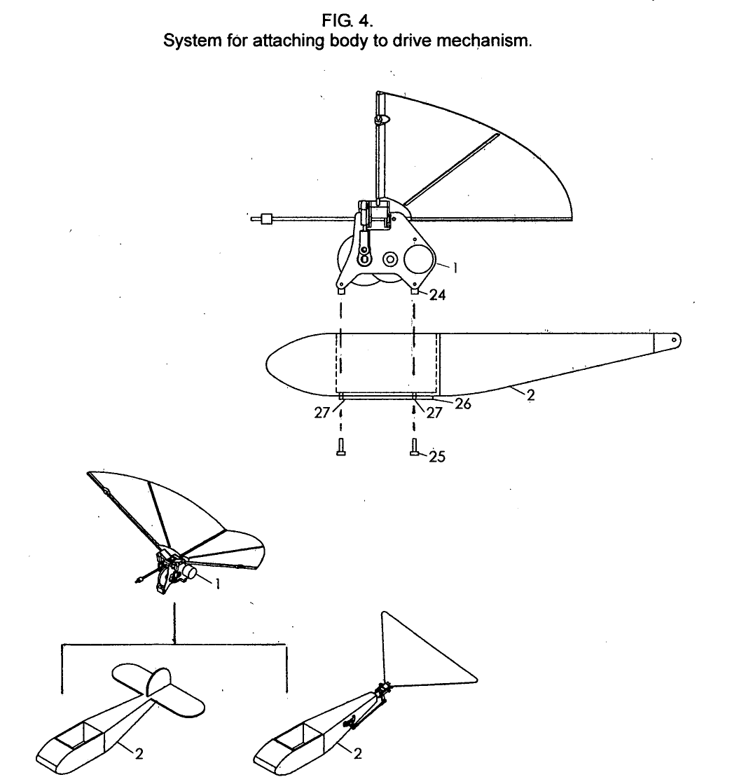

FIG. 4 shows the modular body attachment. The drive unit (1) contains mounting blocks (24) where the body (2) can be mounted onto the drive unit using fasteners (25). The fasteners may be machine screws, or any other type of fastener. Alternatively, a quick-release mechanism could be used, where the parts simply slide or snap together, and can be released by pressing a lever, or by some other method. In the preferred embodiment, the body contains a reinforced area (26) for mounting the drive unit. Holes (27) for mounting the drive unit would be located in the reinforced area. The reinforced area may be constructed of aircraft plywood, fiberglass, plastic, or other hard material attached to the body. The body itself may be constructed of any stiff, lightweight material, such as balsa wood, balsa wood covered with a plastic film, styrofoam, hollow fiberglass, etc. The mounting blocks may be fastened to the drive unit in such a manner as to swivel, thus allowing the use of different-shaped bodies. Some bodies may have a flat bottom, while others may have a curved bottom. A single mounting block with more than one hole, or any number of mounting blocks, could substitute for the two shown.

In the preferred embodiment, the wing membrane is entirely supported by a structure attached to the drive unit. Alternatively, the body may include a hard point for attaching the rear edge of the wing membrane (8). This may consist of a reinforced hole into which a screw can be inserted, to secure the wing. Alternatively, the wing membrane may be hooked onto a post projecting from the body, or secured with any other appropriate type of fastener.

I claim:

1. An ornithopter, wherein the improvement comprises:
a. for each wing, a cord connecting the leading edge of the wing to a forward point on the body of the ornithopter,
whereby said wing may be supported against excessive bending under load, and
whereby the need for bracing elements within said wing may be reduced or eliminated.

2. The ornithopter of claim 1, wherein said forward point on the body of the ornithopter comprises a row of hooks.

3. The ornithopter of claim 1, wherein said forward point on the body of the ornithopter comprises a movable fastener.

4. An ornithopter, wherein the improvement comprises:
a. a modular drive unit,
b. an airframe,
c. means for removably attaching said drive unit to said airframe,
whereby a variety of airframes can be used with a common drive unit.

5. The ornithopter of claim 4, wherein said airframe has a three-dimensional shape.

6. A steering mechanism for ornithopters, comprising:
a. two servos mounted in the body of the ornithopter,
b. pushrods connecting the output arms of said servos to a pair of bellcranks, said bellcranks being arranged side by side near the aft end of the ornithopter body and in such a manner that the output arm of each bellcrank moves up and down in response to the movement of its corresponding servo,
c. a ball-and-socket joint, located in the output arm of each bellcrank, and having a hole through the ball,
d. a tail pivot rod, protruding aft and hinged onto the body of the ornithopter, between said bellcranks, in such a manner that the rod can move up and down in an arc,
e. an airfoil, mounted onto said tail pivot rod, in such a manner that the airfoil can rotate about the long axis of the rod, and move up and down along with the rod,
f. a fastener, free to slide within the through-hole of each ball-and-socket joint, and secured into the base of said airfoil,
whereby said bellcranks moving together cause said airfoil to move up and down, and
whereby said bellcranks moving in opposite directions cause said airfoil to rotate about the axis of said tail pivot rod.

7. The steering mechanism of claim 6, wherein said servos are controlled by an electronic mixing device.

8. The steering mechanism of claim 6, wherein said fastener is not free to slide within the through-hole of said ball-and-socket joint.

9. The steering mechanism of claim 6, wherein said ball-and-socket joint is replaced by a simple hole for said fastener.
